(19) United States
(12) Patent Application Publication
(10) Pub. No.: US 2012/0211971 A1
(43) Pub. Date: Aug. 23, 2012

(54) TEMPORARY HOLDING METHOD FOR AIRBAG AND AIRBAG MODULE

(75) Inventors: Nobuaki OKAMURA, Kiyosu-shi (JP); Osamu Hirose, Kiyosu-shi (JP)

(73) Assignee: TOYODA GOSEI CO., LTD., Kiyosu-shi (JP)

(21) Appl. No.: 13/355,701

(22) Filed: Jan. 23, 2012

(30) Foreign Application Priority Data
Feb. 18, 2011 (JP) 2011-033476

(51) Int. Cl. B60R 21/16

(52) U.S. Cl. 280/728.2

(57) ABSTRACT

In a first step, a heat shrinkable film having openings on respective ends is arranged such that its axis extends along a deploying direction of a foldable portion of an airbag. The heat shrinkable film surrounds the foldable portion in a state where the first opening on the leading side in the deploying direction is arranged forward of the foldable portion in the deploying direction. In a second step, a surface perpendicular to the deploying direction of the airbag is defined as a projection plane. The heat shrinkable film shrinks by heat such that, on the projection plane, a first opening projected area, on which the first opening of the heat shrinkable film in the deploying direction is projected, becomes smaller than and included in a foldable portion projected area on which a deployment leading side portion of the foldable portion is projected.

### BACKGROUND OF THE INVENTION

The present invention relates to a method for temporarily holding a foldable portion of an airbag in a folded state, and to an airbag module having the foldable portion that is temporarily held by application of the method.

A steering wheel that incorporates an airbag device has been widely known as a device for protecting a driver from an impact when the impact is applied to a vehicle such as a car by, for example, a collision. An airbag unit used in the airbag device includes an airbag and a retainer. The airbag includes a foldable portion that is arranged in a folded state. The foldable portion of the airbag is inflated forward in the deploying direction while unfolding the foldable portion by inflation gas, that is, while deploying the foldable portion. The retainer is arranged on the trailing side of the foldable portion in the deploying direction. The retainer is mainly used to sandwich and fasten a gas inlet of the airbag between the retainer and the back holder.

According to the above-mentioned airbag unit, the foldable portion needs to be temporarily held in the folded state until the airbag unit is installed in the steering wheel. Therefore, various methods for temporarily holding the foldable portion have been proposed.

One of the methods forms the airbag module by wrapping the entire airbag including the foldable portion and the retainer with one piece of cloth. The cloth wraps the foldable portion from the leading side in the deploying direction. Although part of the cloth on the leading side of the foldable portion in the deploying direction temporarily holds the foldable portion in the folded state until the airbag module is installed in the airbag device such as during transportation, the cloth hinders the airbag from deploying. Therefore, slits are provided at part of the cloth on the leading side of the foldable portion in the deploying direction. The slits serve as a fragile portion that is weaker than other portions. The deploying airbag easily and promptly breaks the cloth from the slits.

In Japanese Laid-Open Patent Publication No. 10-181493, a temporary holding method has been proposed that covers the entire airbag unit and the retainer by a heat shrinkable film instead of the cloth. The heat shrinkable film covers the foldable portion from the leading side in the deploying direction in the same manner as the above-mentioned cloth. According to this temporary holding method, the airbag is compressed and becomes compact in size by the heat shrinkable film that shrinks by heat. Slits are discontinuously provided as the fragile portion at part of the heat shrinkable film on the leading side of the foldable portion in the deploying direction. The deploying airbag breaks the heat shrinkable film from the discontinuously extending slits.

However, the fragile portion needs to be provided separately in both the conventional temporary holding method that wraps the airbag and the retainer with the cloth, and the temporary holding method of the above publication in which the airbag and the retainer are covered by the heat shrinkable film. This undesirably increases costs.

### SUMMARY OF THE INVENTION

Accordingly, it is an objective of the present invention to provide a temporary holding method for an airbag and an airbag module that smoothly deploys the airbag without separately providing a fragile portion.

To achieve the foregoing objective and in accordance with one aspect of the present invention, a temporary holding method for airbag is provided that is applied to an airbag unit including an airbag having a foldable portion and a retainer, the method temporarily holds the foldable portion of the airbag in a folded state. The foldable portion is arranged in the airbag in the folded state, and deploys forward in a deploying direction by an inflation gas, the retainer is arranged on the trailing side of the foldable portion in the deploying direction. The temporary holding method comprising: a first step for surrounding the foldable portion by a heat shrinkable film having first and second openings on respective ends and an axis, wherein the foldable portion is surrounded in a state in which the first opening, which is located on the leading side of the foldable portion in the deploying direction, is located forward of the foldable portion in the deploying direction by arranging the heat shrinkable film such that the axis of the heat shrinkable film extends along the deploying direction of the foldable portion; and a second step, in which a surface perpendicular to the deploying direction of the foldable portion is defined as a projection plane and in which the heat shrinkable film shrinks by heat such that a first opening projected area on which the first opening of the heat shrinkable film is projected becomes smaller than and included in a foldable portion projected area on which a deployment leading side portion of the foldable portion is projected.

In accordance with another aspect of the present invention, an airbag module is provided that includes an airbag unit. The airbag unit includes an airbag and a foldable portion arranged in the airbag in a folded state. The foldable portion of the airbag deploys forward in the deploying direction by an inflation gas. The retainer is arranged on the trailing side of the foldable portion in the deploying direction. The airbag module further includes an annular heat shrinkable film including first and second openings on respective ends and an axis. The heat shrinkable film surrounds the foldable portion with the axis arranged along the deploying direction of the foldable portion. The first opening of the heat shrinkable film is located on the leading side of the foldable portion in the deploying direction, and the second opening of the heat shrinkable film is located on the trailing side of the foldable portion in the deploying direction. When a surface perpendicular to the deploying direction of the foldable portion is defined as a projection plane, a first opening projected area on which the first opening of the heat shrinkable film is projected is smaller than and included in a foldable portion projected area on which a deployment leading side portion of the foldable portion is projected.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a partial cross-sectional view illustrating a steering wheel with an airbag device according to one embodiment of the present invention;

FIGS. 2A and 2B are schematic cross-sectional views for explaining a step for temporarily holding the foldable portion of the airbag in a folded state;

FIG. 3 is a schematic front view as viewed from the left side of the airbag module of FIG. 2B; and

FIG. 4 is a schematic back view as viewed from the right side of the airbag module of FIG. 2B.

### DETAILED DESCRIPTION OF THE PREFERRED EMBODIMENTS

A temporary holding method for an airbag and an airbag module according to one embodiment of the present invention will now be described with reference to drawings. The invention is embodied in a steering wheel with an airbag device.

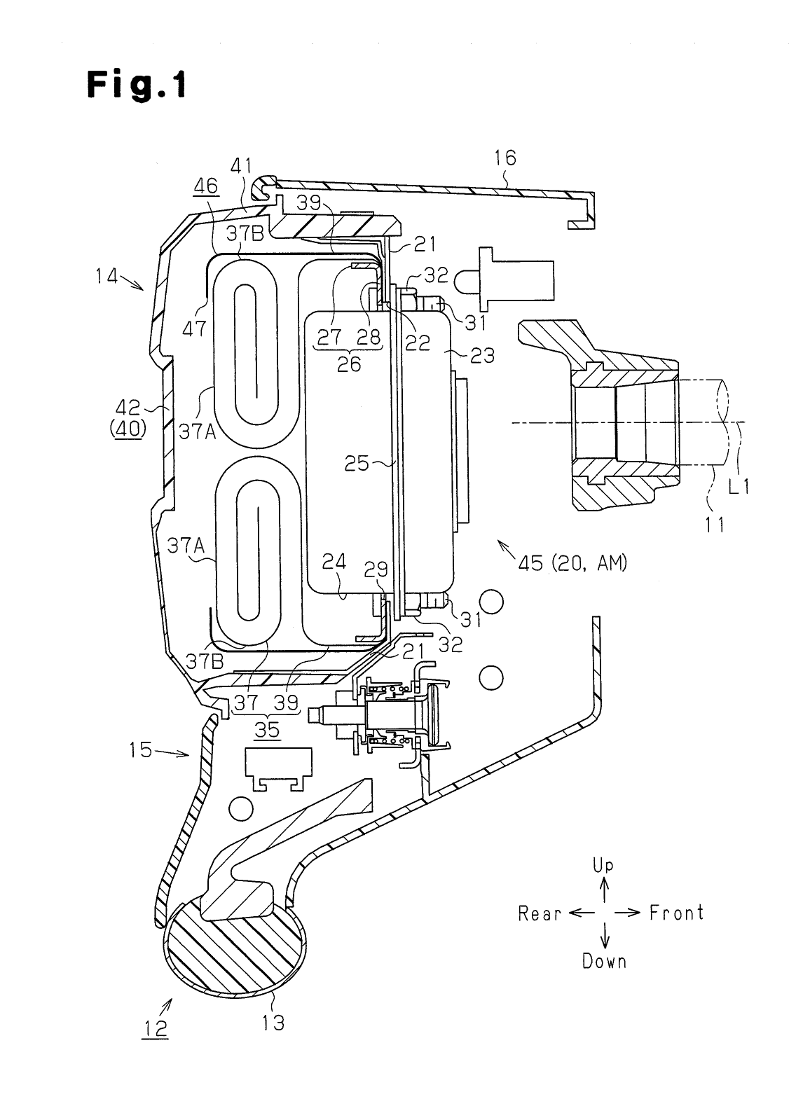

As shown in FIG. 1, a steering shaft 11, which rotates about a rotation axis L1, is located forward of a driver's seat of a vehicle (rightward of FIG. 1). A steering wheel 12 is mounted on the rear end of the steering shaft 11 to rotate integrally with the steering shaft 11. The steering wheel 12 includes a rim portion (also referred to as a ring) 13, a pad portion 14, and a spoke portion 15.

The rim portion 13 has a substantially annular shape about the steering shaft 11. The pad portion 14 is arranged in a space surrounded by the rim portion 13. The front side portion of the pad portion 14 is covered by a lower cover 16. The spoke portion 15 is located between the rim portion 13 and the pad portion 14.

An airbag device 20 is arranged inside the pad portion 14. The airbag device 20 includes a back holder 21, an inflator (gas generator) 23, a retainer 26, and an airbag 35.

The back holder 21 is supported by a metal core (not shown) of the steering wheel 12. The back holder 21 has a circular insertion hole 22 the diameter of which is slightly greater than that of the inflator 23.

The inflator 23 has a columnar shape extending along the fore-and-aft direction, and has a substantially cylindrical outer circumferential surface 24. A gas forming agent (not shown) that generates an inflation gas for inflating the airbag 35 is accommodated inside the inflator 23. Gas exhaust nozzles (not shown) are arranged on the outer circumferential surface 24 of the inflator 23 at substantially equal angular intervals along the circumferential direction. The inflation gas generated by the gas forming agent is exhausted radially outward from the gas exhaust nozzles.

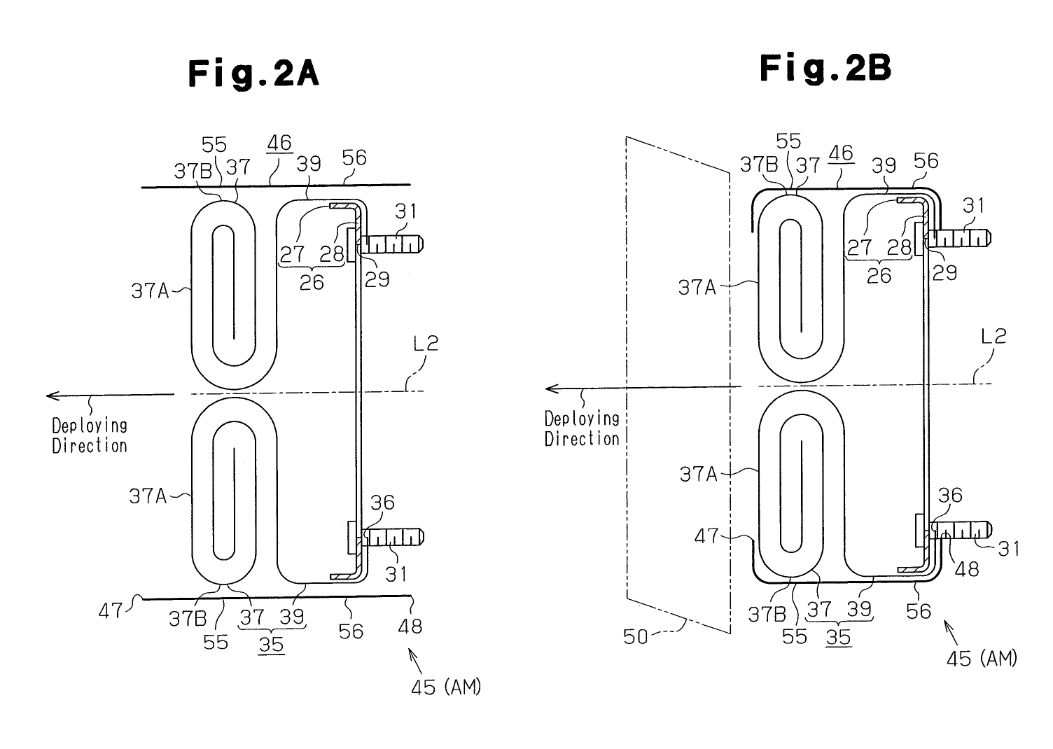

The inflator 23 has a flange portion 25, which protrudes radially outward from the outer circumferential surface 24. Part of the inflator 23 that is rearward of the flange portion 25 is inserted in the insertion hole 22 of the back holder 21 and is inserted in the airbag 35 through a gas inlet portion 36 (see FIGS. 2A and 2B), which will be described later. The flange portion 25 is arranged forward of the back holder 21. As the inflator 23, a type of an inflator may be used in which a partition wall of a high-pressure gas cylinder filled with high-pressure gas is broken by explosive to exhaust an inflation gas instead of the type that uses the above-mentioned gas forming agent.

The retainer 26 is mainly used when sandwiching and fastening part of the airbag 35 around the gas inlet portion 36 between the retainer 26 and the back holder 21. The retainer 26 includes a side wall portion 27 and a bottom wall portion 28, and forms a ring as a whole.

The side wall portion 27 has a substantially rectangular loop shape, and surrounds the inflator 23 in a state separate from the inflator 23. The bottom wall portion 28 closes the space between the front end of the side wall portion 27 and the outer circumferential surface 24 of the inflator 23, and has a rectangular outer shape. An insertion hole 29, which has a diameter slightly larger than that of the outer circumferential surface 24 of the inflator 23, is provided at the center of the bottom wall portion 28. Part of the inflator 23 rearward of the flange portion 25 is inserted in the insertion hole 29 so that the bottom wall portion 28 is arranged rearward of the back holder 21. Bolts 31, which are for example clinch studs, are fixed to several positions (four in this embodiment) around the insertion hole 29 of the bottom wall portion 28 (see FIG. 4). The bolts 31 extend forward along the rotation axis L1 of the steering shaft 11.

The trailing side of the airbag 35 in the direction along the rotation axis L1 (the direction toward the driver, left side in FIG. 1) is defined as a leading side in the deploying direction. The airbag 35 is inflated in the deploying direction by the inflation gas exhausted from the gas exhaust nozzles of the inflator 23. The airbag 35 has high strength and is formed into a bag shape by a cloth such as a flexible woven cloth. The airbag 35 is open at its front end, and the opening forms the gas inlet portion 36 (see FIGS. 2A and 2B). In the present embodiment, the leading side and the trailing side of the airbag 35 in the deploying direction are opposite to the front side and the rear side of the vehicle. Therefore, to clearly distinguish the directions, the leading side and the trailing side of the airbag 35 in the deploying direction are described as the “leading side in the deploying direction” and the “trailing side in the deploying direction”.

The airbag 35 includes a foldable portion 37 folded on the rear side of the inflator 23, and a mounting portion 39 located on the front side of the foldable portion 37 and mounted on the back holder 21. In FIG. 1, to facilitate illustration, the foldable portion 37 is illustrated in a state where the foldable portion 37 is folded into a spiral or a rolled state, but the folding manner of the foldable portion 37 is not limited to this. The foldable portion 37 has a square pillar-like outer shape extending rearward along the rotation axis L1 (deploying direction) from the retainer 26.

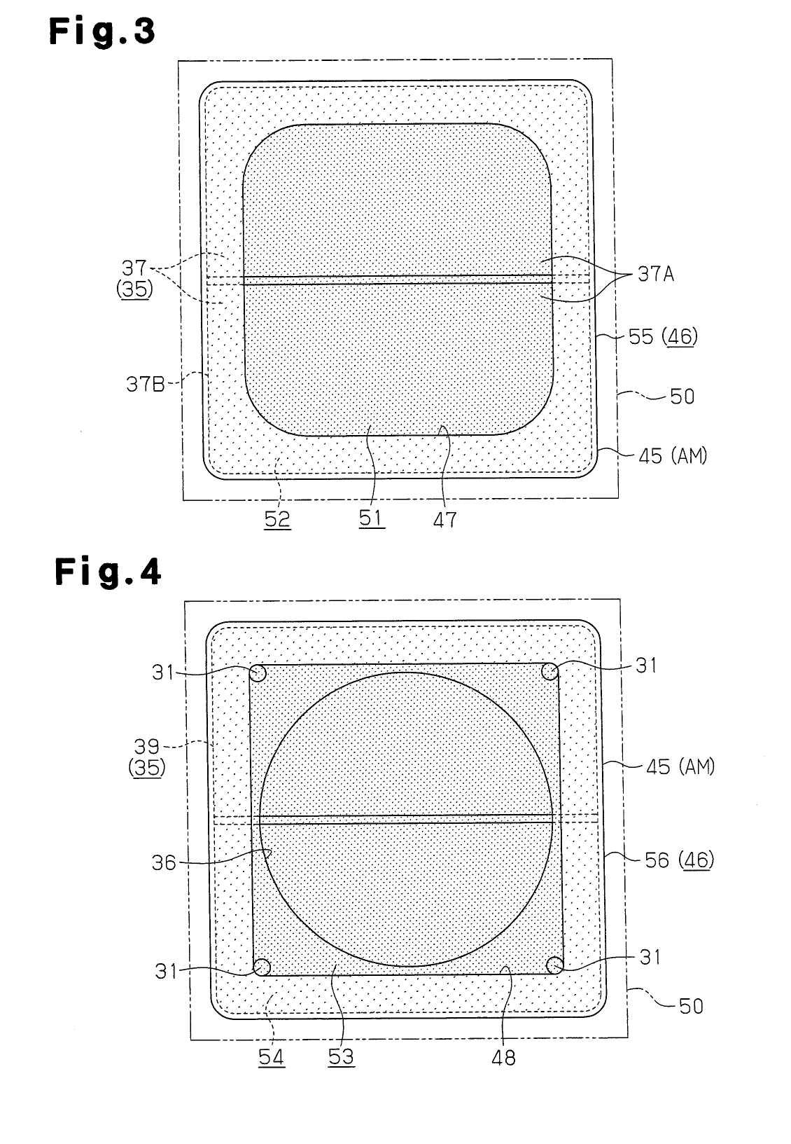

As shown in FIG. 2B, a surface perpendicular to the deploying direction of the foldable portion 37 is defined as a projection plane 50. In the projection plane 50, a foldable portion projected area 52 on which the foldable portion 37 is projected substantially matches with a retainer projected area 54 on which the retainer 26 is projected (see FIGS. 3 and 4).

As shown in FIG. 1, the bolts 31 are inserted in part of the airbag 35 around the gas inlet portion 36, the back holder 21, and the flange portion 25. When nuts 32 are screwed to the bolts 31, the part of the airbag 35 around the gas inlet portion 36 and the back holder 21 are fastened between the bottom wall portion 28 of the retainer 26 and the flange portion 25.

The steering wheel 12 further includes a bag cover 40 integrally formed of a soft resin. The bag cover 40 includes a cylindrical wall portion 41 surrounding the airbag 35, and a lid portion 42, which closes the cylindrical wall portion 41 from the rear side. The cylindrical wall portion 41 of the bag cover 40 is placed over the back holder 21 from the rear and outside of the back holder 21 and is engaged with the back holder 21. The bag cover 40 is movable in the fore-and-aft direction together with the back holder 21.

A breakable portion (not shown) that is thinner than other parts of the lid portion 42 is formed in the lid portion 42. The breakable portion partitions the lid portion 42 into door portions. The breakable portion has less strength than other parts of the lid portion 42. When the airbag 35 deploys, the lid portion 42 is easily broken from the breakable portion. The broken door portions open rearward and apart from the rotation axis L1 (radially outward), with hinge portions (not shown) serving as supporting points.

The steering wheel 12 with the airbag device 20 is basically formed as described above. In the steering wheel 12, the airbag 35 and the retainer 26 are handled as an airbag unit 45 in which the airbag 35 and the retainer 26 are integrated or combined by insertion of the bolts 31 in the parts around the gas inlet portion 36. The airbag 35 and the retainer 26 are transported or installed in the steering wheel 12 in the form of the airbag unit 45.

Since the airbag unit 45 has the foldable portion 37 as described above, the foldable portion 37 needs to be temporarily held in a folded state until the airbag unit 45 is installed in the steering wheel 12. However, it is required that the structure for temporarily holding the foldable portion 37 does not hinder the airbag 35 from deploying.

In the present embodiment, the airbag 35, that is, the foldable portion 37 is temporarily held in the following manner that satisfies the above requirements.

In this manner, an annular heat shrinkable film 46 having openings 47, 48 on respective ends is used as shown in FIG. 2A. To distinguish the openings 47, 48, the opening on the leading side of the foldable portion 37 in the deploying direction is referred to as a first opening 47, and the opening on the trailing side of the foldable portion 37 in the deploying direction is referred to as a second opening 48.

The heat shrinkable film 46 is formed of a film having the property that shrinks by heat. The heat shrinkable film 46 may be formed of, for example, polyester, vinyl chloride, polystyrene, polypropylene, polyamide, polyethylene, or polyethylene terephthalate. Also, the heat shrinkable film 46 may be formed of a single layer or several layers.

The heat shrinkable film 46 is arranged such that its axis L2 extends along the deploying direction of the foldable portion 37 and surrounds the airbag unit 45 in a manner that satisfies the following conditions.

### <Condition 1>

As shown in FIG. 3, part of the projection plane 50 on which the first opening 47 on the leading side of the heat shrinkable film 46 in the deploying direction is projected is referred to as a first opening projected area 51. Part of the projection plane 50 on which a deployment leading side portion 37A of the foldable portion 37 is projected is referred to as a foldable portion projected area 52. The heat shrinkable film 46 shrinks by heat such that the first opening projected area 51 becomes smaller than and included in the foldable portion projected area 52.

In FIG. 3, the foldable portion projected area 52 is expressed by halftone dots. The overlapped portion of the foldable portion projected area 52 and the first opening projected area 51 is expressed by denser (darker) halftone dots than the foldable portion projected area 52.

### <Condition 2>

As shown in FIG. 4, part of the projection plane 50 on which the second opening 48 on the trailing side of the heat shrinkable film 46 in the deploying direction is projected is referred to as a second opening projected area 53. Part of the projection plane 50 on which the retainer 26 is projected is referred to as a retainer projected area 54. The heat shrinkable film 46 shrinks by heat such that the second opening projected area 53 becomes smaller than and included in the retainer projected area 54.

In FIG. 4, the retainer projected area 54 is expressed by halftone dots. The overlapped portion of the retainer projected area 54 and the second opening projected area 53 is expressed by denser halftone dots, that is, darker halftone dots than the retainer projected area 54.

### <Condition 3>

As shown in FIG. 3, a portion 55 of the heat shrinkable film 46 that surrounds the foldable portion 37 shrinks by heat and is in close contact with an outer circumferential surface 37B of the foldable portion 37.

In this manner, the airbag unit 45 is integrated with the heat shrinkable film 46 by being surrounded by the heat shrinkable film 46, and the foldable portion 37 is held in the folded state. Hereinafter, a module formed by the airbag unit 45 and the heat shrinkable film 46 is referred to as an “airbag module AM”.

In the airbag module AM, through execution of the following first step and second step in order, the heat shrinkable film 46 temporarily holds the foldable portion 37 in the folded state.

### <First Step>

In the first step, the annular heat shrinkable film 46 having the first and second openings 47, 48 on respective ends is used as shown in FIG. 2A. As for the heat shrinkable film 46, it is preferable that the first opening projected area 51 on the projection plane 50 be slightly greater than the foldable portion projected area 52, on which the deployment leading side portion 37A of the foldable portion 37 having a square pillar-like outer shape is projected. Also, as the heat shrinkable film 46, it is preferable that the second opening projected area 53 be slightly greater than the retainer projected area 54 on the projection plane 50. Also, the length of the heat shrinkable film 46 is longer than that of the airbag unit 45 in the deploying direction.

Subsequently, the orientation, or the posture, of the annular heat shrinkable film 46 is adjusted such that the axis L2 extends along the deploying direction. The airbag unit 45 is covered by the heat shrinkable film 46 the orientation, or the posture, of which is adjusted so that the airbag unit 45 is surrounded by the heat shrinkable film 46.

Furthermore, operation for adjusting the position of the airbag unit 45 in the deploying direction with respect to the annular heat shrinkable film 46 is performed. The operation is performed such that the first opening 47 on the leading side of the heat shrinkable film 46 in the deploying direction is located forward of the foldable portion 37 in the deploying direction, and the second opening 48 on the trailing side of the heat shrinkable film 46 in the deploying direction is located rearward of the bottom wall portion 28 of the retainer 26, more specifically, rearward of the gas inlet portion 36 of the airbag 35 in the deploying direction.

### <Second Step>

In the second step, the entire heat shrinkable film 46 is heated. By the heating, the portion 55 of the heat shrinkable film 46 that surrounds the foldable portion 37 shrinks toward the axis L2 of the heat shrinkable film 46, that is, radially inward as shown in FIG. 2B. The shrunk portion 55 closely contacts most part of the outer circumferential surface 37B of the foldable portion 37. In FIG. 2B, the portion 55 is shown in a state separate from the outer circumferential surface 37B.

Also, by heating, the first opening 47 on the leading side of the heat shrinkable film 46 in the deploying direction shrinks in a direction toward the axis L2, that is, radially inward by an amount greater than the portion 55. This is because the foldable portion 37 is located inward of the portion 55, and the foldable portion 37 restricts shrinkage of the portion 55. However, there is nothing that restricts the shrinkage located inward of the first opening 47 and the peripheral portion. By the shrinkage, the first opening projected area 51 becomes smaller than and included in the foldable portion projected area 52 on the projection plane 50 as shown in FIG. 3.

By heating, a portion 56 of the heat shrinkable film 46 that surrounds the side wall portion 27 of the retainer 26 shrinks in the direction toward the axis L2 of the heat shrinkable film 46, that is, radially inward as shown in FIG. 2B. At this time, the side wall portion 27 restricts shrinkage of the portion 56.

Furthermore, by heating, the second opening 48 on the trailing side of the heat shrinkable film 46 in the deploying direction shrinks toward the axis L2, that is, radially inward by an amount greater than the portion 56 surrounding the retainer 26 as shown in FIGS. 2B and 4. The reason for this is as follows. Since bolts 31 are located inward of the second opening 48 and the peripheral portion, the bolts 31 restrict the shrinkage of the second opening 48. However, since the bolts 31 are located inward of the side wall portion 27, the degree of restricting the heat shrinkage of the heat shrinkable film 46 is smaller than the degree of restricting the shrinkage by the side wall portion 27. By the shrinkage, the second opening projected area 53 becomes smaller than and included in the retainer projected area 54 on the projection plane 50.

The operation of the present embodiment formed as described above will now be described separately under the following titles: <Before installation of airbag module AM>, <During installation of airbag module AM>, <When airbag device 20 is not operated after installation of airbag module AM>, and <When airbag device 20 is operated after installation of airbag module AM>.

### <Before Installation of Airbag Module AM>

As shown in FIG. 2B, the portion 55 of the heat shrinkable film 46 surrounding the foldable portion 37 of the airbag 35 restricts the foldable portion 37 from moving in the direction apart from the axis L2 of the heat shrinkable film 46, that is, radially outward, or prevents the foldable portion 37 from being unfolded.

In the present embodiment, the portion 55 shrinks by heat, and closely contacts a wide part of the outer circumferential surface 37B of the foldable portion 37. The gap between the portion 55 and the outer circumferential surface 37B is reduced, or becomes substantially zero by the close contact. This further restricts the foldable portion 37 from moving radially outward.

In particular, in the present embodiment, the foldable portion 37 has a square pillar-like outer shape, and the foldable portion projected area 52 on the projection plane 50 is substantially rectangular. In this case, according to the conventional temporary holding method in which the entire airbag and the retainer are wrapped by one piece of cloth, it is difficult to wrap without forming a gap between the cloth and the corners of the foldable portion. However, according to the present embodiment, in which the heat shrinkable film 46 shrinks by heat, the gap between the heat shrinkable film 46 and the corners of the foldable portion 37 is also reduced, or is substantially zero since the heat shrinkable film 46 deforms along the outer shape of the foldable portion 37 and closely contacts the foldable portion 37.

Also, the first opening 47 on the leading side in the deploying direction and the peripheral portion that shrunk by heat become a wall that is perpendicular to the deploying direction on the leading side of the outer circumference portion of the foldable portion 37 in the deploying direction. The wall prevents the foldable portion 37 from moving forward in the deploying direction with respect to the heat shrinkable film 46, or prevents the foldable portion 37 from being unfolded.

The restriction keeps the foldable portion 37 in the folded state.

Furthermore, in the heat shrinkable film 46, the second opening 48 on the trailing side in the deploying direction and the peripheral portion that shrunk by heat become a wall that is perpendicular to the deploying direction on the trailing side of the outer circumference portion of the retainer 26 in the deploying direction. The wall restricts the retainer 26 from moving rearward in the deploying direction with respect to the heat shrinkable film 46. Thus, the heat shrinkable film 46 restricts the airbag unit 45 from moving along the axis L2 forward in the deploying direction or rearward in the deploying direction of the foldable portion 37.

### <During Installation of Airbag Module AM>

The outer portion of the airbag module AM is formed by the heat shrinkable film 46. The outer surface of the heat shrinkable film 46 is smoother than the conventional module in which the outer portion is formed of cloth. Furthermore, the heat shrinkable film 46 does not have the fragile portion such as slits, unlike the case with the cloth. Thus, when the airbag module AM is installed in the steering wheel 12, the heat shrinkable film 46 slides smoothly with respect to the components of the airbag device 20 such as the back holder 21, or an installation jig even if the heat shrinkable film 46 comes in contact with them, and the heat shrinkable film 46 does not get caught easily.

<When Airbag Device 20 is not Operated after Airbag Module AM is Assembled>

In the airbag device 20, during normal operation when an impact is not applied to the vehicle from the front, the inflation gas is not exhausted from the gas exhaust nozzles of the inflator 23. Since the inflation gas is not supplied to the airbag 35, the foldable portion 37 of the airbag 35 is kept in the folded state.

<When Airbag Device 20 is Operated after Installation of Airbag Module AM>

When an impact is applied to the vehicle from the front due to, for example, front collision, the body of the driver acts to be tilted forward due to inertia. In the airbag device 20, the inflation gas is exhausted from the gas exhaust nozzles of the inflator 23 in response to the impact, and the inflation gas is supplied to the airbag 35. The inflation gas inflates the airbag 35 while unfolding or deploying the airbag 35 forward in the deploying direction, that is, toward the driver.

At this time, the first opening 47 of the heat shrinkable film 46 is located on the leading side of the foldable portion 37 in the deploying direction. The first opening 47 permits the foldable portion 37 of the airbag 35 that is supplied with the inflation gas to inflate while being unfolded, or deployed. In this manner, the first opening 47 on the leading side of the heat shrinkable film 46 in the deploying direction exerts the same function as the conventional fragile portion.

The deploying airbag 35 applies pressure on the bag cover 40, in particular, on the lid portion 42, and the lid portion 42 breaks into door portions at the breakable portion. The broken door portions open rearward with the hinge portions serving as supporting points, and openings are formed in between. Through the opening, the airbag 35 deploys rearward. Since the deployed airbag 35 is located between the driver who is tilted forward by the impact of the front collision and the steering wheel 12, the driver who is tilted forward is restrained by the airbag 35, and is protected from the impact.

The present embodiment has the following advantages.

(1) In the first step, the foldable portion 37 is surrounded (FIG. 2A) in a state where the first opening 47 on the leading side of the heat shrinkable film 46 in the deploying direction is located forward of the foldable portion 37 of the airbag 35 in the deploying direction. In the second step, the heat shrinkable film 46 shrinks by heat (FIG. 3) such that the first opening projected area 51 becomes smaller than and included in the foldable portion projected area 52 on the projection plane 50 perpendicular to the deploying direction.

Therefore, the first opening 47 and the peripheral portion that are shrunk by heat restrict the foldable portion 37 from moving forward of the deploying direction, that is, from being unfolded, and keeps the foldable portion 37 in the folded state (FIG. 2B).

Also, the first opening 47 of the heat shrinkable film 46 exerts the same function as the conventional fragile portion. As a result, for example, the fragile portion formed by the slits does not need to be separately formed in the heat shrinkable film 46 for deploying the foldable portion 37. This reduces the costs of the airbag module AM, and moreover, the costs of the airbag device 20.

(2) As the heat shrinkable film 46, one that is formed into a loop shape before surrounding the foldable portion 37 is used. In the first step, the annular heat shrinkable film 46 is placed over the foldable portion 37 so that the foldable portion 37 is surrounded by the heat shrinkable film 46 (FIG. 2A).

Therefore, the foldable portion 37 can be surrounded by the heat shrinkable film 46 by preparing the heat shrinkable film 46 that is formed into a loop shape in advance, and simply placing the heat shrinkable film 46 over the foldable portion 37.

(3) In the first step, the heat shrinkable film 46 surrounds the retainer 26 (FIG. 2A) in a state where the second opening 48 on the trailing side of the heat shrinkable film 46 in the deploying direction is located rearward of the retainer 26 in deploying direction. In the second step, the heat shrinkable film 46 shrinks by heat such that the second opening projected area 53 becomes smaller than and included in the retainer projected area 54 on the projection plane 50 (FIG. 4).

Therefore, the second opening 48 and the peripheral portion that shrunk by heat restrict the retainer 26 from moving rearward in the deploying direction of the foldable portion 37 with respect to the heat shrinkable film 46. The heat shrinkable film 46 can restrict the foldable portion 37 from moving forward of the deploying direction and rearward of the deploying direction. As a result, the heat shrinkable film 46 is prevented from falling off the airbag unit 45 during, for example, transportation.

(4) The airbag unit 45 and the heat shrinkable film 46 form the airbag module AM. The airbag unit 45 includes the airbag 35 in which the foldable portion 37 deploys in the deploying direction by the inflation gas, and the retainer 26 arranged rearward of the foldable portion 37 in the deploying direction. The heat shrinkable film 46 has the first and second openings 47, 48 and has a loop-like shape. The heat shrinkable film 46 surrounds the foldable portion 37 with the axis L2 arranged along the deploying direction of the foldable portion 37.

The first opening projected area 51 is smaller than and included in the foldable portion projected area 52 on the projection plane 50 that is perpendicular to the deploying direction (FIGS. 2A and 3).

Therefore, like the advantage (1) described above, the fragile portion formed of, for example, slits does not need to be separately provided in the heat shrinkable film 46 to smoothly deploy the airbag 35.

(5) The portion 55 of the heat shrinkable film 46 surrounding the foldable portion 37 closely contacts with at least part of the outer circumferential surface 37B of the foldable portion 37 by heat shrinkage (FIG. 2B).

Thus, the foldable portion 37 is prevented from moving in the direction apart from the axis L2 of the heat shrinkable film 46, that is, radially outward, or from being unfolded.

Although the foldable portion 37 has a square pillar-like outer shape, the gap between the heat shrinkable film 46 and the corners is reduced, or is substantially zero.

(6) The second opening projected area 53 on which the second opening 48 is projected is smaller than and included in the retainer projected area 54 on the projection plane 50 (FIG. 4).

Therefore, like the advantage (3) as described above, the heat shrinkable film 46 is prevented from falling off the airbag unit 45 during, for example, transportation.

(7) The annular heat shrinkable film 46 that has a smooth outer surface is used for surrounding the airbag unit 45 (FIG. 2A). Also, the heat shrinkable film 46 does not have the fragile portion such as slits.

Therefore, the airbag module AM is easily installed in the steering wheel 12 without getting caught by components of the airbag device 20 such as the back holder 21, or the installation jig. This facilitates the assembling of the airbag module AM.

(8) The heat shrinkable film 46 is used for surrounding the airbag unit 45. The heat shrinkable film 46 closely contacts the airbag 35 by heat shrinkage (FIG. 2B). Thus, as compared to a case in which the airbag unit 45 is wrapped by one piece of cloth, the volume of the airbag 35 is considerably reduced, and the size of the airbag module AM is reduced.

The present invention may be modified in the following forms.

In the first step, only the foldable portion 37 of the airbag 35 may be surrounded by the annular heat shrinkable film 46. In this case, the retainer 26 and the mounting portion 39 of the airbag 35 are not surrounded by the heat shrinkable film 46.

In the second step, the first opening 47 on the leading side of the heat shrinkable film 46 in the deploying direction shrinks on the leading side of the foldable portion 37 in the deploying direction. However, the second opening 48 on the trailing side of the heat shrinkable film 46 in the deploying direction does not shrink on the trailing side of the retainer 26 and the mounting portion 39 in the deploying direction.

In the above-mentioned modified embodiment also, the airbag 35 smoothly deploys even though the fragile portion is not provided.

In the first step, one piece of the heat shrinkable film 46 may be used and wound around the airbag unit 45. The ends of the heat shrinkable film 46 may be joined by, for example, welding to form a loop shape having the first and second openings 47, 48 on respective ends. In this case also, the foldable portion 37 can be surrounded by the heat shrinkable film 46, which has the openings 47, 48 on respective ends and has the axis L2 arranged along the deploying direction of the foldable portion 37, in a state where the first opening 47 on the leading side in the deploying direction is arranged forward of the foldable portion 37 in the deploying direction. Also, the retainer 26 can be surrounded by the heat shrinkable film 46 in the state where the second opening 48 on the trailing side in the deploying direction is located rearward of the retainer 26 in the deploying direction.

The present invention can be applied to a module in which the foldable portion 37 is folded into an outer shape other than the square pillar-like shape. The foldable portion 37 may be formed into, for example, a circular cylinder, a frustum of a cone, a frustum of a polygonal pyramid such as a frustum of a square pyramid.

In this case, the annular shape of the heat shrinkable film is also changed in accordance with the outer shape of the foldable portion 37.

The present invention may be applied to an airbag device that is different from the airbag device 20, which is installed in the steering wheel and protects the driver, that is, a driver's seat airbag device. The different type of the airbag device includes, for example, a front passenger seat airbag device, which is installed in the instrument panel and protects the occupant in the front passenger seat, and a side airbag device, which is installed in a seat back of the vehicle seat and protects the occupant from an impact applied from the side of the vehicle.

Therefore, the present examples and embodiments are to be considered as illustrative and not restrictive and the invention is not to be limited to the details given herein, but may be modified within the scope and equivalence of the appended claims.

1. A temporary holding method for airbag applied to an airbag unit including an airbag having a foldable portion and a retainer, the method temporarily holds the foldable portion of the airbag in a folded state,
wherein the foldable portion is arranged in the airbag in the folded state, and deploys forward in a deploying direction by an inflation gas, the retainer is arranged on the trailing side of the foldable portion in the deploying direction, the temporary holding method comprising:
a first step for surrounding the foldable portion by a heat shrinkable film having first and second openings on respective ends and an axis, wherein the foldable portion is surrounded in a state in which the first opening, which is located on the leading side of the foldable portion in the deploying direction, is located forward of the foldable portion in the deploying direction by arranging the heat shrinkable film such that the axis of the heat shrinkable film extends along the deploying direction of the foldable portion; and
a second step, in which a surface perpendicular to the deploying direction of the foldable portion is defined as a projection plane and in which the heat shrinkable film shrinks by heat such that a first opening projected area on which the first opening of the heat shrinkable film is projected becomes smaller than and included in a foldable portion projected area on which a deployment leading side portion of the foldable portion is projected.

2. The temporary holding method for airbag according to claim 1,
wherein the heat shrinkable film is formed into an annular shape before surrounding the foldable portion, and
the annular heat shrinkable film is placed over the foldable portion to surround the holding portion in the first step.

3. The temporary holding method for airbag according to claim 1,
wherein the second opening of the heat shrinkable film is located on the trailing side of the foldable portion in the deploying direction, and the first step includes surrounding the retainer by the heat shrinkable film in a state in which the second opening is located rearward of the retainer in the deploying direction of the foldable portion, and
the second step includes shrinking the heat shrinkable film such that a second opening projected area on which the second opening of the heat shrinkable film is projected becomes smaller than and included in a retainer projected area on which the retainer is projected on the projection plane.

4. An airbag module comprising an airbag unit,
the airbag unit including:
an airbag;
a foldable portion arranged in the airbag in a folded state,
wherein the foldable portion of the airbag deploys forward in the deploying direction by an inflation gas; and
a retainer arranged on the trailing side of the foldable portion in the deploying direction,
the airbag module further comprising:
an annular heat shrinkable film including first and second openings on respective ends and an axis, the heat shrinkable film surrounding the foldable portion with the axis arranged along the deploying direction of the foldable portion,
the first opening of the heat shrinkable film is located on the leading side of the foldable portion in the deploying direction, and the second opening of the heat shrinkable film is located on the trailing side of the foldable portion in the deploying direction, and
wherein, when a surface perpendicular to the deploying direction of the foldable portion is defined as a projection plane, a first opening projected area on which the first opening of the heat shrinkable film is projected is smaller than and included in a foldable portion projected area on which a deployment leading side portion of the foldable portion is projected.

5. The airbag module according to claim 4,
wherein the foldable portion has an outer circumferential surface, and
wherein a portion of the heat shrinkable film surrounding the foldable portion closely contacts at least part of the outer circumferential surface of the foldable portion by heat shrinkage.

6. The airbag module according to claim 4,
wherein the heat shrinkable film surrounds the retainer in addition to the foldable portion, and
wherein a second opening projected area on which the second opening of the heat shrinkable film is projected is smaller than and included in a retainer projected area on which the retainer is projected on the projection plane.
